(19) United States
(12) Patent Application Publication
(10) Pub. No.: US 2023/0071160 A1
(43) Pub. Date: Mar. 9, 2023

(54) COMPILER GENERATION FOR PARTIAL EVALUATION

(71) Applicant: Oracle International Corporation, Redwood Shores, CA (US)

(72) Inventors: David Leopoldseder, Vienna (AT); Christian Wimmer, Belmont, CA (US); Florian Latifi, Linz (AT)

(73) Assignee: Oracle International Corporation, Redwood Shores, CA (US)

(21) Appl. No.: 17/466,904

(22) Filed: Sep. 3, 2021

(51) Int. Cl. G06F 8/41

(52) U.S. Cl. CPC G06F 8/4443

(57) ABSTRACT

A method for compiling source code may include obtaining an abstract syntax tree (AST) node of an AST generated from the source code. The AST node may include a first value and a second value. The method may further include obtaining, for the AST node, an intermediate representation (IR) graph, determining that the first value is a constant, propagating the first value to the IR graph to obtain a first partially evaluated IR graph, and generating, for the AST node, a compiler. The first partially evaluated IR graph corresponds to a result of executing the compiler. The method may further include determining, by the compiler, that the second value is a constant, propagating, by the compiler, the second value to the first partially evaluated IR graph to obtain a second partially evaluated first IR graph, and executing the AST node using the second partially evaluated IR graph.

### BACKGROUND

Partial evaluation optimizes code by precomputing static information at compile time. Previous work has shown that leveraging profiling information and using partial evaluation directives in interpreters may result in compiled code efficiency. Partial evaluation of an interpreter is also known as the first Futamura projection. However, partial evaluation of the interpreter may incur additional warmup because user code is first executed in a baseline tier to gather the profiling information. In addition, partial evaluation of language interpreters specializes interpreter code to the dynamic types used at runtime to create efficient target code, which is compile-time intensive and may further cause long application warmups.

Applying partial evaluation to a partial evaluation algorithm (also known as the second Futamura projection) generates language-specific compilers from interpreters, typically resulting in reduced compile time relative to partial evaluation of the interpreters (i.e., the first Futamura projection). However, no practical implementation of partial evaluation of a partial evaluation algorithm has been used in a state-of-the-art language runtime, as the problems of code size explosion for compiler generation and associated warmup time increases remain unsolved problems.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method for compiling source code including obtaining an abstract syntax tree (AST) node of an AST generated from the source code. The AST node includes a first value and a second value. The method further includes obtaining, for the AST node, an intermediate representation (IR) graph, determining that the first value is a constant, propagating the first value to the IR graph to obtain a first partially evaluated IR graph, and generating, for the AST node, a compiler. The first partially evaluated IR graph corresponds to a result of executing the compiler. The method further includes determining, by the compiler, that the second value is a constant, propagating, by the compiler, the second value to the first partially evaluated IR graph to obtain a second partially evaluated first IR graph, and executing the AST node using the second partially evaluated IR graph.

In general, in one aspect, one or more embodiments relate to a system for compiling source code including a computer processor and a repository configured to store the source code and an abstract syntax tree (AST) generated from the source code. The AST includes an AST node including a first value and a second value. The system further includes a compiler generator executing on the computer processor and configured to: obtain, for the AST node, an intermediate representation (IR) graph, determine that the first value is a constant, propagate the first value to the IR graph to obtain a first partially evaluated IR graph, and generate, for the AST node, a compiler. The first partially evaluated IR graph corresponds to a result of executing the compiler. The compiler generator is further configured to determine, by the compiler, that the second value is a constant, and propagate, by the compiler, the second value to the first partially evaluated IR graph to obtain a second partially evaluated first IR graph. The system further includes a runtime system executing on the computer processor and configured to execute the AST node using the second partially evaluated IR graph.

In general, in one aspect, one or more embodiments relate to a method for compiling source code including obtaining an abstract syntax tree (AST) node of an AST generated from the source code. The AST node includes a first value and a second value. The method further includes sending the AST node to a compiler generator configured to perform: obtaining, for the AST node, an intermediate representation (IR) graph, determining that the first value is a constant, propagating the first value to the IR graph to obtain a first partially evaluated IR graph, and generating, for the AST node, a compiler. The first partially evaluated IR graph corresponds to a result of executing the compiler. The compiler generator is further configured to perform determining, by the compiler, that the second value is a constant, propagating, by the compiler, the second value to the first partially evaluated IR graph to obtain a second partially evaluated first IR graph, and transmitting the second partially evaluated IR graph. The method further includes receiving, from the compiler generator, the second partially evaluated IR graph and executing the AST node using the second partially evaluated IR graph.

Other aspects of the invention will be apparent from the following description and the appended claims.

### BRIEF DESCRIPTION OF DRAWINGS

FIG. 1A and FIG. 1B show a system in accordance with one or more embodiments of the invention.

FIG. 2A, FIG. 2B, and FIG. 3 show flowcharts in accordance with one or more embodiments of the invention.

FIG. 4A, FIG. 4B, and FIG. 4C show an example in accordance with one or more embodiments of the invention.

FIG. 5A and FIG. 5B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to partial evaluation of source code. An intermediate representation (IR) graph is generated from an abstract syntax tree (AST) node of an abstract syntax tree generated from the source code. For example, the source code may implement a portion of an abstract syntax tree interpreter. Partial evaluation transforms (e.g., optimizes) the IR graph by precomputing static information specific to the AST node. A partially evaluated IR graph may be obtained by propagating one or more constant values in the IR graph. For example, if a constant value is a receiver object of a function invocation, then propagating the constant value in the IR graph may de-virtualize the function invocation by replacing the receiver object with the constant value. As another example, if the constant value is included in an expression, then propagating the constant value in the IR graph may replace the nodes in the IR graph corresponding to the expression with the result of evaluating the expression using the constant value.

A compiler may be generated for the AST node, where the compiler corresponds to the partially evaluated IR graph. At compilation time, the compiler may perform additional partial evaluation to generate a further partially evaluated IR graph, for example, by propagating additional constant values in the partially evaluated IR graph. The AST node may be executed using the further partially evaluated IR graph.

In one or more embodiments, a hybrid partial evaluator selects between a compiler and a generic partial evaluator to partially evaluate an AST node. The generic partial evaluator performs generic partial evaluation that incurs additional overhead to parse and inline function invocations for the AST nodes. For example, the hybrid partial evaluator may select a compiler to partially evaluate the AST node when a compiler has been generated for the AST node. Continuing this example, a compiler may be generated for a frequently executed AST node. Conversely, the hybrid partial evaluator may select the generic partial evaluator to partially evaluate the AST node when no compiler has been generated for the AST node (e.g., for an infrequently executed AST node).

One or more embodiments of the invention are now described using the drawings or images shown in one or more of the various figures described and shown below. The invention should not be limited or constrained by the figures as described.

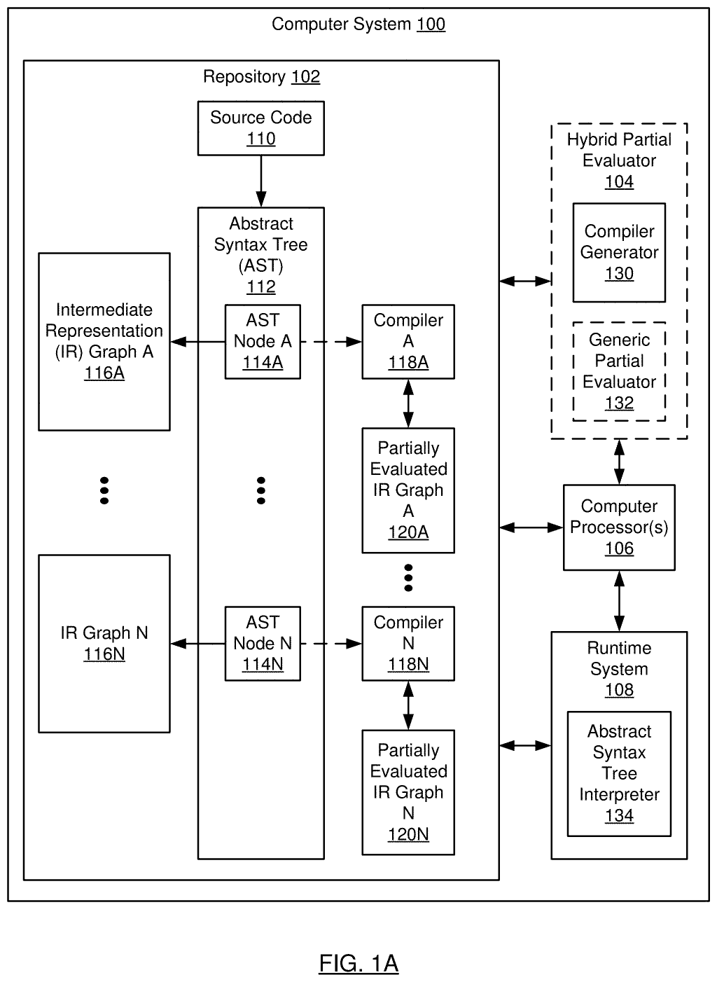

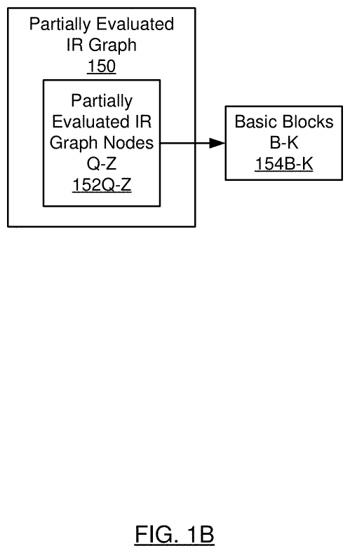

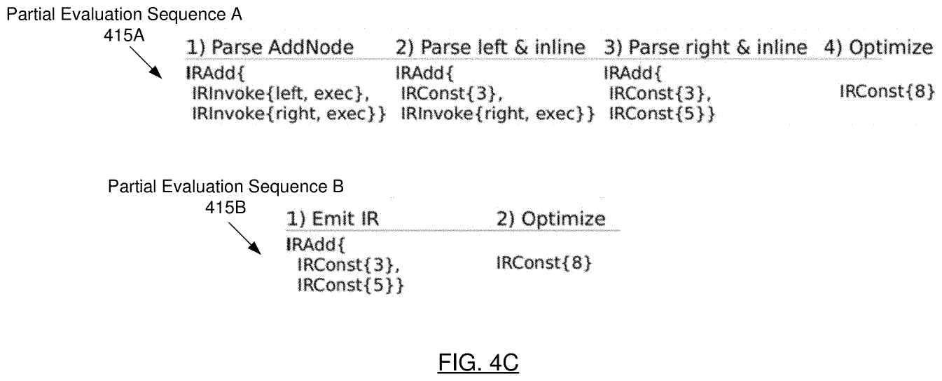

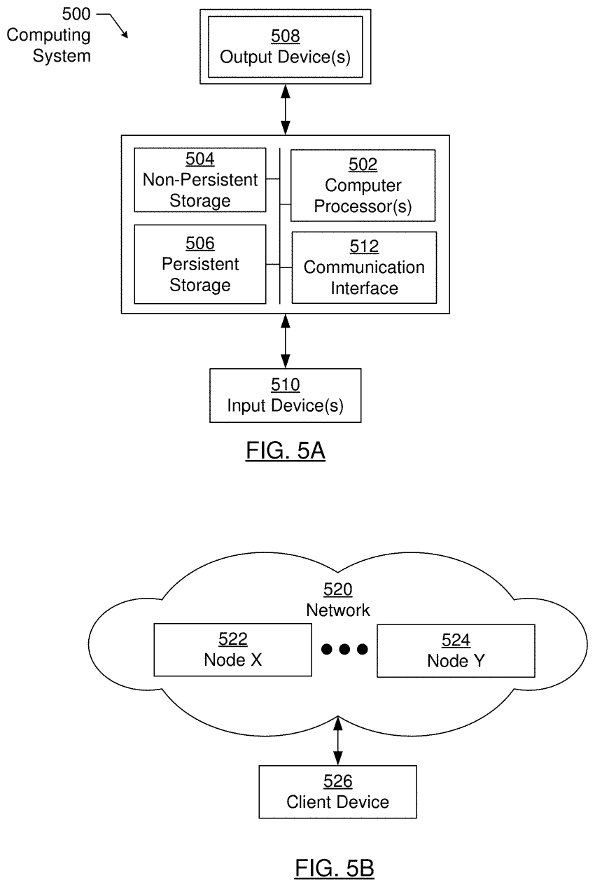

FIG. 1A shows a computer system (100) in accordance with one or more embodiments of the invention. As shown in FIG. 1A, the computer system (100) includes a repository (102), an (optional) hybrid partial evaluator (104), computer processor(s) (106), and a runtime system (108). In one or more embodiments, the computer system (100) takes the form of the computing system (500) described with respect to FIG. 5A and the accompanying description below or take the form of the client device (526) described with respect to FIG. 5B.

In one or more embodiments, the repository (102) is any type of storage unit and/or device (e.g., a file system, database, collection of tables, or any other storage mechanism) for storing data. Further, the repository (102) may include multiple different storage units and/or devices. The multiple different storage units and/or devices may or may not be of the same type or located at the same physical site. The repository (102) may be accessed online via a cloud service (e.g., Oracle Cloud, Amazon Web Services (AWS), Egnyte, Azure, etc.).

In one or more embodiments, the repository (102) includes functionality to store source code (110), an abstract syntax tree (AST) (112), intermediate representation (IR) graphs (116A, 116N), and compilers (118A, 118N). The source code (110) is a collection of computer instructions (e.g., statements) written in a human-readable source programming language (e.g., JavaScript). The source code (110) includes various syntactic constructs of the source programming language. Examples of syntactic constructs include operators, expressions, statements, classes, methods, functions, interfaces, packages, etc.

The source code (110) may include one or more annotations. Examples of annotations in the Truffle language implementation framework of the Graal Virtual Machine (GraalVM) include: @Child, @Children, @ExplodeLoop, etc. An annotation may be used to guide the operation of the abstract syntax tree interpreter (134), the compiler generator (130) and/or the generic partial evaluator (132), as described below.

The abstract syntax tree (AST) (112) is a tree representation of the source code (110). For example, the abstract syntax tree (112) may be generated from the source code (110) by a parser. The abstract syntax tree (112) includes abstract syntax tree (AST) nodes (114A, 114N) corresponding to syntactic constructs of the source code (110). The abstract syntax tree (112) is “abstract” in the sense that the AST nodes (114A, 114N) correspond to structural and/or content-related details of the source code (110) while omitting one or more syntactic details of the source code (110). For example, because grouping parentheses are implicit in the tree structure of the abstract syntax tree (112), the abstract syntax tree (112) may omit AST nodes corresponding to the grouping parentheses.

In one or more embodiments, the runtime system (108) is a virtual machine. A virtual machine is a software implementation of a computing device executing on an underlying computing device (e.g., computer system (100)). A virtual machine may abstract the operating system and hardware of the underlying computing device from instructions that are executed in the virtual machine. The runtime system (108) includes an abstract syntax tree interpreter (134).

The abstract syntax tree interpreter (134) includes functionality to execute the abstract syntax tree (112). For example, the abstract syntax tree (112) may implement a portion of the abstract syntax tree interpreter (134) (e.g., the source code from which the abstract syntax tree (112) is generated may implement a portion of the abstract syntax tree interpreter (134)). Continuing this example, the portion of the abstract syntax tree interpreter (134) may perform an arithmetic operation (e.g., addition, multiplication, etc.) or any other operation performed by the abstract syntax tree interpreter (134).

An intermediate representation (IR) graph (116A) is generated from an AST node (114A) (e.g., by the compiler generator (130) or generic partial evaluator (132)). The IR graph (116A) is a data structure or code used internally by a compiler or virtual machine to represent the source code (110). The IR graph (116A) includes IR nodes corresponding to syntactic constructs of the AST node (114A) from which the IR graph (116A) was generated.

Compilers (118A, 118N) may optionally be generated for AST nodes (114A, 114N) (e.g., by the compiler generator (130)). A compiler may be generated for an AST node that corresponds to a function, operator, or other syntactic construct of the source code. In one or more embodiments, a compiler is generated for an AST node that corresponds to a portion of the source code that is frequently executed. An execution profile may be used to determine that a portion of the source code is frequently executed.

The compilers (118A, 118N) correspond to partially evaluated IR graphs (120A, 120N). A partially evaluated IR graph (120A) is a result of applying partial evaluation to an IR graph (116A) for the AST node (114A). Partial evaluation transforms (e.g., optimizes) the IR graph (116A) by precomputing static information specific to the AST node (114A). For example, partial evaluation may simplify the IR graph (116A) by propagating one or more constant values to variables included in the IR graph (116A). As another example, partial evaluation may simplify the IR graph (116A) by propagating one or more constant values to combine and/or remove nodes of the IR graph (116A). The partially evaluated IR graph (120A) may be generated (e.g., by the compiler generator (130)) when the corresponding compiler (118A) is generated.

In one or more embodiments, the compiler (118A) generates target code in a target programming language. For example, the source programming language may be JavaScript and the target programming language may be Java. Continuing this example, the target programming language may be a native programming language of a virtual machine (e.g., the Java Virtual Machine (JVM)) that implements the runtime system (108).

Turning to FIG. 1B, a partially evaluated IR graph (150) includes partially evaluated IR nodes (152Q-Z). The partially evaluated IR nodes (152Q-Z) correspond to syntactic constructs of the IR graph from which the partially evaluated IR graph (150) was generated. The partially evaluated IR nodes (152Q-Z) may be mapped to basic blocks (154B-K). A basic block (154B) may include a sequence of IR nodes with exactly one entry point and exactly one exit point. For example, the basic block may lack any branches other than a branch that enters the basic block and a branch that exits the basic block.

Returning to FIG. 1A, the hybrid partial evaluator (104) includes the compiler generator (130) and a generic partial evaluator (132). The compiler generator (130) includes functionality to perform specialized, ahead-of-time partial evaluation that is specialized for a particular AST node. The generic partial evaluator (132) includes functionality to perform generic partial evaluation that is independent of any particular AST node. The hybrid partial evaluator (104) includes functionality to select between a compiler (e.g., compiler (118A)) and the generic partial evaluator (132) to partially evaluate an AST node (114A). For example, the hybrid partial evaluator (104) may select a compiler to partially evaluate the AST node (114A) when a compiler (118A) has been generated for the AST node (114A). Conversely, the hybrid partial evaluator (104) may select the generic partial evaluator (132) to partially evaluate the AST node (114A) when no compiler has been generated for the AST node (114A).

In one or more embodiments, the computer processor(s) (106) takes the form of the computer processor(s) (502) described with respect to FIG. 5A and the accompanying description below. In one or more embodiments, the computer processor (106) includes functionality to execute the compiler generator (130) and/or the hybrid partial evaluator (104).

While FIGS. 1A and 1B show a configuration of components, other configurations may be used without departing from the scope of the invention. For example, various components may be combined to create a single component. As another example, the functionality performed by a single component may be performed by two or more components.

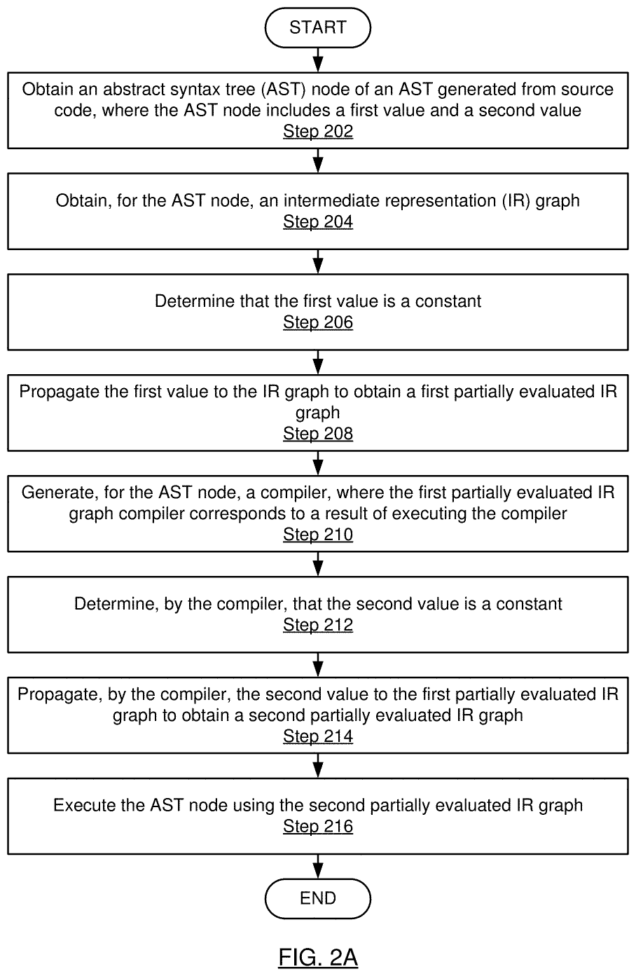

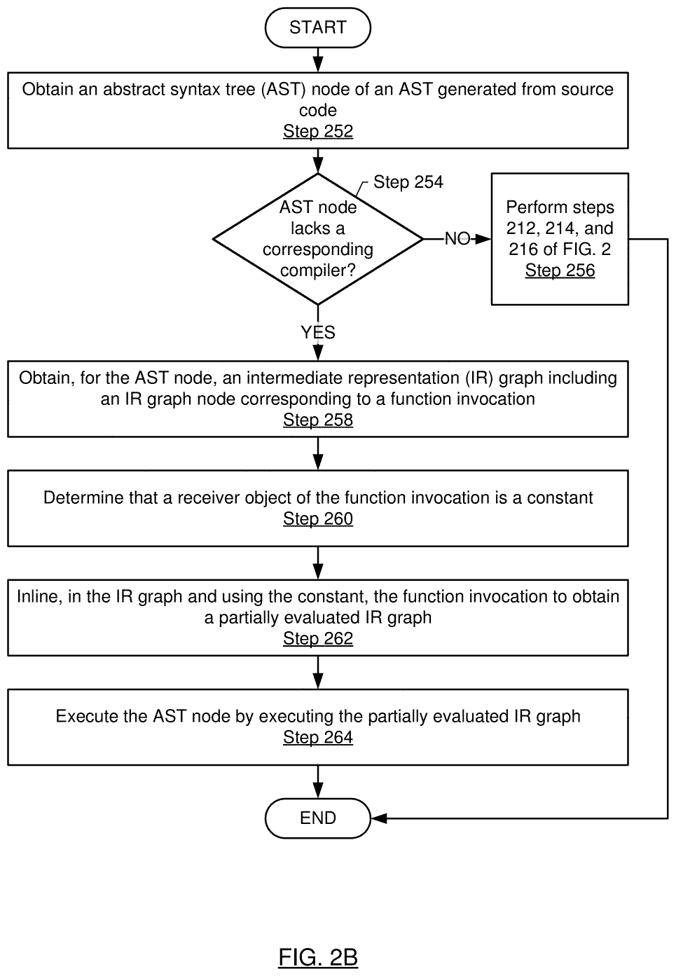

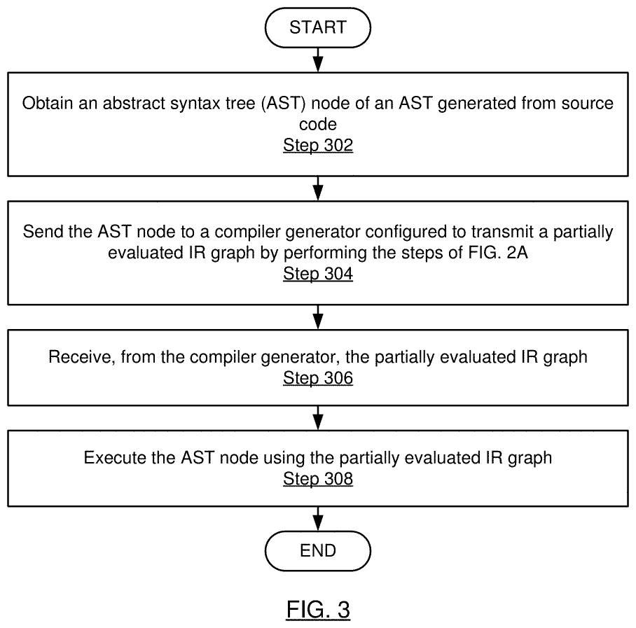

FIG. 2A shows a flowchart in accordance with one or more embodiments of the invention. The flowchart depicts a process for compiling source code. One or more of the steps in FIG. 2A may be performed by the components (e.g., the compiler generator (130), compilers (118A, 118N), and runtime system (108) of the computer system (100)), discussed above in reference to FIG. 1A. In one or more embodiments of the invention, one or more of the steps shown in FIG. 2A may be omitted, repeated, and/or performed in parallel, or in a different order than the order shown in FIG. 2A. Accordingly, the scope of the invention should not be considered limited to the specific arrangement of steps shown in FIG. 2A.

Initially, in Step 202, an abstract syntax tree (AST) node of an AST generated from the source code is obtained. For example, the compiler generator may generate the AST from the source code by executing a parser on the source code. The AST node may include a first value and a second value. For example, the AST node may correspond to an arithmetic expression, a Boolean expression, etc. in the source code that includes one or more of the values included in the AST node. As another example, the AST node may correspond to a loop expression in the source code such that one of the values included in the AST node determines the number of iterations in a loop. As yet another example, the AST node may correspond to a function invocation in the source code where the receiver object of the function invocation is a value included in the AST node.

In one or more embodiments, the AST node is a frequently executed node. The compiler generator may determine that the AST node is a frequently executed node based on a profiling result obtained by profiling the source code. For example, the profiling result may indicate that the portion of the source code corresponding to the AST node is executed a number of times exceeding an execution frequency threshold within a predefined time interval.

In Step 204, an intermediate representation (IR) graph is obtained for the AST node. For example, the compiler generator may obtain the IR graph for the AST node by executing a parser on the AST node. Alternatively, the compiler generator may obtain the IR graph for the AST node from a repository that stores previously generated IR graphs for AST nodes.

In Step 206, it is determined that the first value is a constant. The compiler generator may determine that the first value is a constant if the first value is a primitive value (e.g., a numerical constant) or a string literal. Alternatively, the compiler generator may determine that the first value is a constant using an annotation in the source code. For example, a load of a field value annotated with the Truffle @Child annotation may be determined to be a constant. Still alternatively, a load of a field value from a field declared as a “compilation final” field may be determined to be a constant. In addition, the first value may be determined to be a constant using one or more rules. For example, the first value may be determined to be a constant based on a rule that triggers when one or more properties of the first value and/or the AST node are satisfied.

In Step 208, the first value is propagated to the IR graph to obtain a first partially evaluated IR graph. That is, once the compiler generator determines that the first value is a constant, the compiler generator may use the constant to simplify the IR graph, resulting in the first partially evaluated IR graph. Propagating the first value to the IR graph may result in combining nodes and/or removing nodes of the IR graph. That is, the first value may be used to generate the (simplified) partially evaluated IR graph. For example, if the first value is a receiver object of a function invocation, then propagating the first value to the IR graph may de-virtualize the function invocation (e.g., by replacing the receiver object with the constant determined in Step 206 above). As another example, if the first value is included in an expression, then propagating the first value to the IR graph may replace the nodes in the IR graph corresponding to the expression with the result of evaluating the expression using the constant determined in Step 206 above. As yet another example, if the first value determines the number of iterations in a loop, then propagating the first value to the IR graph may unroll the loop using the constant determined in Step 206 above.

In Step 210, a compiler is generated for the AST node. The first partially evaluated IR graph corresponds to a result of executing the compiler. For example, when the compiler is used to compile the AST node (e.g., in Step 212 and Step 214 below), the compiler may use the first partially evaluated IR graph as a starting point for performing additional partial evaluation during the compilation process.

In Step 212, the compiler determines that the second value is a constant (see description of Step 206 above). For example, the compiler may use additional information that was not available when Step 206 above was performed to determine that the second value is a constant. Continuing this example, the compiler may be a just-in-time (JIT) compiler that has access to values of variables and/or settings in the runtime execution environment of the computing system. As another example, the compiler may determine, using an annotation (e.g., the Truffle Children annotation), that the length of an array, as well as the contents of each array cell, are constants.

In Step 214, the compiler propagates the second value to the first partially evaluated IR graph to obtain a second partially evaluated IR graph (see description of Step 208 above). That is, the compiler performs additional partial evaluation on the first partially evaluated IR graph to generate the second partially evaluated IR graph. The compiler may compile the AST node by assigning the nodes of the first partially evaluated IR graph to basic blocks, and then visiting the basic blocks in reverse post-order while performing partial evaluation on the nodes in the visited basic blocks to generate the second partially evaluated IR graph. Visiting the basic blocks in reverse post-order may ensure that performing partial evaluation does not reference uninstantiated values or IR nodes. The compiler may emit target code represented in a target language when values included in a visited node are unknown (e.g., non-constant), so that the unknown values may be computed at runtime when the AST node is executed, in Step 216 below.

In Step 216, the AST node is executed using the second partially evaluated IR graph. Unknown values in the second partially evaluated IR graph may be computed at runtime by target code emitted in Step 214 above. Examples of such unknown values may include non-constant branch conditions and non-constant receivers of function invocations.

FIG. 2B shows a flowchart in accordance with one or more embodiments of the invention. The flowchart depicts a process for compiling source code. One or more of the steps in FIG. 2B may be performed by the components (e.g., the hybrid partial evaluator (104), generic partial evaluator (132), and runtime system (108) of the computer system (100)), discussed above in reference to FIG. 1A. In one or more embodiments of the invention, one or more of the steps shown in FIG. 2B may be omitted, repeated, and/or performed in parallel, or in a different order than the order shown in FIG. 2B. Accordingly, the scope of the invention should not be considered limited to the specific arrangement of steps shown in FIG. 2B.

Initially, in Step 252, an abstract syntax tree (AST) node of an AST generated from the source code is obtained (see description of Step 202 above).

If in Step 254 it is determined that the AST node lacks a corresponding compiler, then Step 258 below is executed. Otherwise, if Step 254 it is determined that the AST node has a corresponding compiler, then in Step 256, Steps 212, 214, and 216 of FIG. 2A are performed.

In Step 258, an IR graph is obtained for the AST node (see description of Step 204 above). The IR graph may include an IR graph node corresponding to a function invocation. The generic partial evaluator may obtain the IR graph node corresponding to the function invocation by parsing an execute method (e.g., represented as bytecode) of the AST node.

In Step 260, it is determined that a receiver object of the function invocation is a constant (see description of Step 204 above). For example, the generic partial evaluator may replace the this parameter in the parsed IR graph with a constant that represents the receiver object.

In Step 262, the function invocation is inlined, in the IR graph and using the constant, to obtain a partially evaluated IR graph. For example, the generic partial evaluator may replace the normal execution path of the function invocation with the starting node of a new IR graph corresponding to the inlined function invocation. The generic partial evaluator may iterate over the nodes in the partially evaluated IR graph and attempt to further simplify (e.g., further apply partial evaluation to) the partially evaluated IR graph.

In Step 264, the AST node is executed using the partially evaluated IR graph (see description of Step 216 above).

The process of FIG. 2B may execute a generic loop that dispatches between generic partial evaluation logic that parses and then inlines different types of IR graph nodes. In contrast, the specialized partial evaluation process of FIG. 2A bypasses the parsing and inlining of IR graph nodes.

FIG. 3 shows a flowchart in accordance with one or more embodiments of the invention. The flowchart depicts a process for compiling source code. One or more of the steps in FIG. 3 may be performed by the components (e.g., the compiler generator (130), compilers (118A, 118N), and runtime system (108) of the computer system (100)), discussed above in reference to FIG. 1A. In one or more embodiments of the invention, one or more of the steps shown in FIG. 3 may be omitted, repeated, and/or performed in parallel, or in a different order than the order shown in FIG. 3. Accordingly, the scope of the invention should not be considered limited to the specific arrangement of steps shown in FIG. 3.

Initially, in Step 302, an abstract syntax tree (AST) node of an AST generated from the source code is obtained (see description of Step 202 above).

In Step 304, the AST node is sent to a compiler generator configured to transmit a partially evaluated intermediate representation (IR) graph by performing the steps of FIG. 2A. The AST node may be sent to the compiler generator via a network.

In Step 306, the partially evaluated IR graph is received from the compiler generator. The partially evaluated IR graph may be received from the compiler generator via the network.

In Step 308, the AST node is executed using the partially evaluated IR graph (see description of Step 216 above).

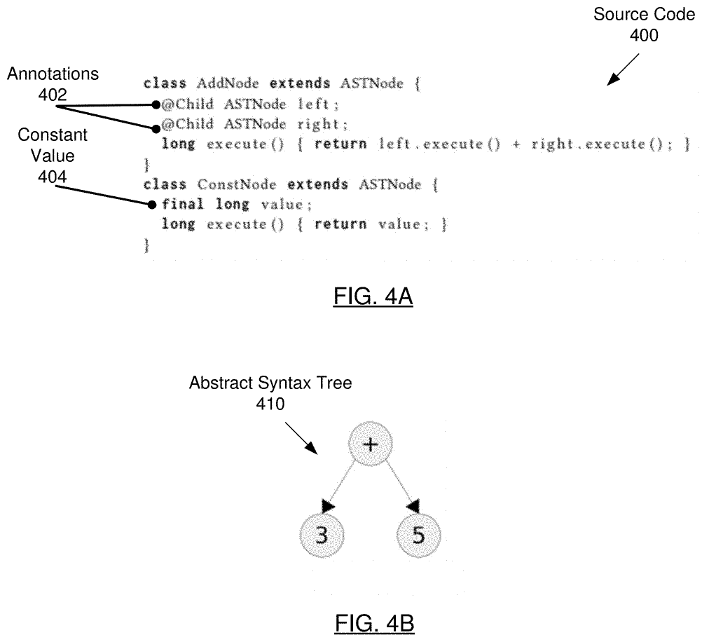

FIG. 4A, FIG. 4B, and FIG. 4C show an implementation example in accordance with one or more embodiments. The implementation example is for explanatory purposes only and not intended to limit the scope of the invention. One skilled in the art will appreciate that implementation of embodiments of the invention may take various forms and still be within the scope of the invention.

FIG. 4A shows source code (400) ((110) in FIG. 1A) that implements a simple abstract syntax tree (AST) interpreter that adds long constants. Annotations (402) on the left and right fields of the AddNode class indicate that loads of values from the left and right fields may be propagated as constants during partial evaluation. The execute method of the AddNode class calls both the left and right children nodes and returns the sum of the two long values. The ConstNode class has a constant value (404) which is a final long field returned by the execute method. The final directive indicates that the corresponding value is static information to be propagated during partial evaluation. FIG. 4B shows an example abstract syntax tree (410) ((112) in FIG. 1A) generated for the source code (400) of FIG. 4A.

FIG. 4C shows a comparison of how the generic partial evaluator and the compiler generator perform partial evaluation. FIG. 4C shows partial evaluation sequence A (415A), performed by the generic partial evaluator, and partial evaluation sequence B (415B), performed by the compiler generator. The generic partial evaluator performs the following steps in partial evaluation sequence A (415A):

1) parse the AddNode class to generate an intermediate representation (IR) graph add node with left and right child IR graph invoke nodes corresponding to the execute methods of the left and right fields.

2) parse the left field and inline (e.g., propagate) the constant value 3 to an IR graph constant node that replaces the left child IR graph invoke node.

3) parse the right field and inline the constant value 5 to another IR graph constant node that replaces the right child IR graph invoke node.

4) optimize the IR graph add node by replacing the IR graph add node with a single IR graph constant node with the constant value 8 resulting from adding the constant values for the left and right child IR graph constant nodes.

In contrast, the compiler generator performs the following steps in partial evaluation sequence B (415B):

1) directly generate an IR graph add node to perform addition on the left and right child IR graph constant nodes that have the constant values 3 and 5 resulting from propagating the constant values 3 and 5 of the left and right fields. That is, the compiler generator bypasses the parsing and inlining steps 1, 2, and 3 above of partial evaluation sequence A (415A).

The compiler generator generates a compiler corresponding to the IR graph add node to perform the additional partial evaluation step below at compilation time.

2) optimize the IR graph add node by replacing the IR graph add node with a single IR graph constant node with the constant value 8 resulting from adding the constant values for the left and right child IR graph constant nodes. This step is the same as step 4 above of partial evaluation sequence A (415A). Thus, partial evaluation sequence B (415B) performs two fewer steps to generate the same IR graph as partial evaluation sequence A (415A).

Embodiments disclosed herein may be implemented on a computing system specifically designed to achieve an improved technological result. When implemented in a computing system, the features and elements of this disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities that implement the features and elements of the disclosure.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments disclosed herein may be implemented on a node of a distributed system that is connected to other nodes. By way of another example, embodiments disclosed herein may be implemented on a distributed computing system having multiple nodes, where each portion disclosed herein may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments disclosed herein.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The above description of functions presents only a few examples of functions performed by the computing system of FIG. 5A and the nodes and/or client device in FIG. 5B. Other functions may be performed using one or more embodiments disclosed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for compiling source code, comprising:
obtaining a first abstract syntax tree (AST) node of an AST generated from the source code, wherein the first AST node comprises a first value and a second value;
obtaining, for the first AST node, a first intermediate representation (IR) graph;
determining that the first value is a constant;
in response to determining that the first value is a constant, propagating the first value to the first IR graph to obtain a first partially evaluated first IR graph;
generating, for the first AST node, a compiler, wherein the first partially evaluated first IR graph corresponds to a result of executing the compiler;
determining, by the compiler, that the second value is a constant;
in response to determining that the second value is a constant, propagating, by the compiler, the second value to the first partially evaluated first IR graph to obtain a second partially evaluated first IR graph; and
executing the first AST node using the second partially evaluated first IR graph.

2. The method of claim 1, further comprising:
obtaining a second AST node of the AST;
determining that the second AST node lacks a corresponding compiler; and
in response to determining that the second AST node lacks a corresponding compiler:
obtaining, for the second AST node, a second IR graph comprising an IR graph node corresponding to a function invocation,
determining that a receiver object of the function invocation is a constant,
inlining, in the second IR graph and using the constant, the function invocation to obtain a partially evaluated second IR graph, and
executing the second AST node using the partially evaluated second IR graph.

3. The method of claim 1,
wherein the source code comprises an annotation, and
wherein the compiler determines that the second value is a constant based on the annotation.

4. The method of claim 1, wherein the first AST node further comprises a third value, the method further comprising:
determining that the third value is a non-constant, and
in response to determining that the third value is a non-constant, evaluating the third value when the first AST node is executed.

5. The method of claim 1,
wherein the first AST node corresponds to a loop in the source code,
wherein the first value determines a number of iterations in the loop, and
wherein propagating the first value to the first IR graph comprises:
unrolling the loop using the first value.

6. The method of claim 1, further comprising:
profiling the source code to obtain a profiling result; and
determining, using the profiling result, that a portion of the source code corresponding to the AST node is executed a number of times exceeding an execution frequency threshold within a time interval,
wherein the first AST node is obtained in response to determining that the portion of the source code is executed the number of times exceeding the execution frequency threshold.

7. The method of claim 1,
wherein the first AST node corresponds to an expression in the source code comprising the first value, and
wherein propagating the first value to the first IR graph comprises:
simplifying the expression using the first value.

8. A system for compiling source code, comprising:
a computer processor;
a repository configured to store the source code, an abstract syntax tree (AST) generated from the source code, wherein the AST comprises a first AST node comprising a first value and a second value;
a compiler generator executing on the computer processor and configured to:
obtain, for the first AST node, a first intermediate representation (IR) graph,
determine that the first value is a constant,
in response to determining that the first value is a constant, propagate the first value to the first IR graph to obtain a first partially evaluated first IR graph,
generate, for the first AST node, a compiler, wherein the first partially evaluated first IR graph corresponds to a result of executing the compiler,
determine, by the compiler, that the second value is a constant, and
in response to determining that the second value is a constant, propagate, by the compiler, the second value to the first partially evaluated first IR graph to obtain a second partially evaluated IR graph; and
a runtime system executing on the computer processor and configured to execute the first AST node using the second partially evaluated first IR graph.

9. The system of claim 8, further comprising a hybrid partial evaluator executing on the computer processor and configured to:
obtain a second AST node of the AST;
determine that the second AST node lacks a corresponding compiler; and
in response to determining that the second AST node lacks a corresponding compiler:
obtain, for the second AST node, a second IR graph comprising an IR graph node corresponding to a function invocation,
determine that a receiver object of the function invocation is a constant, and
inline, in the second IR graph and using the constant, the function invocation to obtain a partially evaluated second IR graph,
wherein the runtime system is further configured to execute the second AST node using the partially evaluated second IR graph.

10. The system of claim 8,
wherein the source code comprises an annotation, and
wherein the compiler determines that the second value is a constant based on the annotation.

11. The system of claim 8,
wherein the first AST node further comprises a third value,
wherein the compiler generator is further configured to determine that the third value is a non-constant, and
wherein the runtime system is further configured to, in response to determining that the third value is a non-constant, evaluate the third value when the first AST node is executed.

12. The system of claim 8,
wherein the first AST node corresponds to a loop in the source code,
wherein the first value determines a number of iterations in the loop, and
wherein the compiler generator is further configured to propagate the first value to the first IR graph by unrolling the loop using the first value.

13. The system of claim 8, wherein the compiler generator is further configured to:
profile the source code to obtain a profiling result, and
determine, using the profiling result, that a portion of the source code corresponding to the AST node is executed a number of times exceeding an execution frequency threshold within a time interval,
wherein the compiler generator obtains the first AST node in response to determining that the portion of the source code is executed the number of times exceeding the execution frequency threshold.

14. The system of claim 8,
wherein the first AST node corresponds to an expression in the source code comprising the first value, and
wherein the compiler generator is further configured to propagate the first value to the first IR graph by simplifying the expression using the first value.

15. A method for compiling source code, comprising:
obtaining a first abstract syntax tree (AST) node of an AST generated from the source code, wherein the first AST node comprises a first value and a second value;
sending the first AST node to a compiler generator configured to perform:
obtaining, for the first AST node, a first intermediate representation (IR) graph,
determining that the first value is a constant,
in response to determining that the first value is a constant, propagating the first value to the first IR graph to obtain a first partially evaluated first IR graph,
generating, for the first AST node, a compiler, wherein the first partially evaluated first IR graph corresponds to a result of executing the compiler,
determining, by the compiler, that the second value is a constant,
in response to determining that the second value is a constant, propagating, by the compiler, the second value to the first partially evaluated first IR graph to obtain a second partially evaluated first IR graph, and
transmitting the second partially evaluated first IR graph;
receiving, from the compiler generator, the second partially evaluated first IR graph; and
executing the first AST node using the second partially evaluated first IR graph.

16. The method of claim 15, further comprising:
obtaining a second AST node of the AST;
sending the second AST node to the compiler generator, wherein the compiler generator is further configured to perform:
determining that the second AST node lacks a corresponding compiler; and
in response to determining that the second AST node lacks a corresponding compiler:
obtaining, for the second AST node, a second IR graph comprising an IR graph node corresponding to a function invocation,
determining that a receiver object of the function invocation is a constant,
inlining, in the second IR graph and using the constant, the function invocation to obtain a partially evaluated second IR graph, and
transmitting the partially evaluated second IR graph;
receiving, from the compiler generator, the partially evaluated second IR graph; and
executing the second AST node using the partially evaluated second IR graph.

17. The method of claim 15,
wherein the source code comprises an annotation, and
wherein the compiler determines that the second value is a constant based on the annotation.

18. The method of claim 15, wherein the first AST node further comprises a third value, the method further comprising:
wherein the first AST node further comprises a third value,
wherein the compiler generator is further configured to perform determining that the third value is a non-constant, and
wherein the method further comprises, in response to determining that the third value is a non-constant, evaluating the third value when the first AST node is executed.

19. The method of claim 15,
wherein the first AST node corresponds to a loop in the source code,
wherein the first value determines a number of iterations in the loop, and
wherein propagating the first value to the first IR graph comprises:
unrolling the loop using the first value.

20. The method of claim 15, wherein the compiler generator is further configured to perform:
profiling the source code to obtain a profiling result; and
determining, using the profiling result, that a portion of the source code corresponding to the AST node is executed a number of times exceeding an execution frequency threshold within a time interval,
wherein the first AST node is obtained in response to determining that the portion of the source code is executed the number of times exceeding the execution frequency threshold.
